(19) United States
(12) Patent Application Publication
(10) Pub. No.: US 2006/0143226 A1
(43) Pub. Date: Jun. 29, 2006

(54) Apparatus, method and program product for integrating applications

(76) Inventor: Tateo Kawamura, Yamato-shi (JP)

Correspondence Address: IBM CORPORATION;INTELLECTUAL PROPERTY LAW, 11400 BURNET ROAD, AUSTIN, TX, 78758, US

(21) Appl. No.: 11/299,216

(22) Filed: Dec. 9, 2005

(30) Foreign Application Priority Data
Dec. 24, 2004 (JP) 2004-374631

(51) Int. Cl. G06F 7/00

(52) U.S. Cl. 707/103 R

(57) ABSTRACT

A system for integrating a plurality of applications of exchanging the BO. This system includes a BO receiving section for receiving the BO, a business process definition acquisition section for acquiring a business process definition corresponding to a transmission source and a type of a received BO from a business process definition storage section, a reference definition storage section for storing a reference definition that defines a referenced application, which is an acquisition destination of a value to be set to an attribute of a transmission BO, an attribute setting section for setting the value acquired from the referenced application to the attribute of the transmission BO, a BO transmitting section for transmitting the transmission BO after setting the value, an I/F definition storage section of defining an interface of the BO in each application, and a reference definition generating section for generating the reference definition based on the interface definition.

### FIELD OF THE INVENTION

The present invention generally relates to a technique for transmitting a business object in a computer system configured such that a plurality of applications are executed by a plurality of computers (hereinafter, it will also be referred to as a mere “application”) integrated by an integrated server, and more particularly, to a technique for transmitting a business object from an application to another application by way of the integrated server in the computer system. Throughout the description of the present specification, the “business object” means a logical unit of group of business data used in this type of computer system. Specifically, it is expressed as a combination of an object name identifying the business object and a plurality of data elements composing the business object.

### BACKGROUND OF THE INVENTION

Hitherto, in an organization of a company or the like, a business system is often introduced for every department in the company. Consequently, there has been occurred a situation that each business system has performed only an operation dedicated to the department per se, and any collaborative operation among the different departments could not have been performed. Lack of collaboration between the systems in respective departments, however, will fail to efficiently manage the system as an entire organization. An activity of integrating the applications in respective business systems has therefore been increased.

First, there has been proposed a system called an ERP (Enterprise Resource Planning) as one of the methods of integrating such applications. The ERP system is a system of integrally managing an entire business by storing in an integrated repository all data that are referred to and/or updated on the business executed in the organization. There are some companies which intend to introduce a so-called Big Bang type ERP system. Nevertheless, in order to introduce the Big Bang type ERP system, there are disadvantages such that a cost and a risk for installing it will be increased, and an optimal product may not be selected for every application field. As a result, rather small numbers of organizations have decided to introduce the Big Bang type ERP system under current situations.

Secondly there has also been proposed a system called EAI (Enterprise Application Integration) or BPI (Business Process Integration) in addition to the ERP system described above. EAI or BPI is intended to achieve an efficient management of data or processes by means of organically integrating the plurality of applications. In recent years, an integration of a hub and spoke architecture is mainstream. The integration of the hub and spoke architecture may be achieved in such a way that an integrated server is allocated as a hub, and a plurality of applications are integrated about the hub located at their center. With an execution of a business process, the business object is exchanged among the plurality of applications by way of the integrated server. In order to enable it to make an exchange of such a business object, there is often defined a common business object on the integrated server. For example, an order form of a product is prepared by an order-receiving system and is sent to a production control system. A production scheme is planned in the production control system, and when a production of the product is practically completed, a delivery order is issued to a distribution system. In that case, an order business object is transmitted to the distribution system through the order-receipt system and the production control system, and stored in each of the systems for permitting it to be referenced. The order business object is defined as a common order business object on the integrated server.

In general, there, however, exists a difference in a definition content of the business object in every application. Therefore, an excess or a deficiency of the attribute occurs to the common business object on the integrated server. Even if any excess or deficiency of the attribute could not occur, an irreversible data conversion might be performed due to a difference in an attribute format or a coding scheme. Therefore, in the exchange of the business object through the integrated server (that is, through the common business object), lack of information might occur in the business object, resulting in bringing about a problem to be solved from a viewpoint of collaboration of an application or applications by the use of the integrated server.

Hereinafter, this will be described depending upon the types of the common business object. First, a case where only a common attribute is exchanged between the applications will be considered. Namely, it is a case where a logical AND of the business objects inherent in each of the applications is treated as a common business object. In this case, since any business object having no common attribute cannot be primarily exchanged on the integrated server, lack of information must occur.

Meanwhile, another case will be considered where the attribute containing therein both of an attribute defined by an application at a transmitting side and an attribute defined by an application at a receiving side is exchanged. Namely, it is the case where a logical OR of the business objects inherent in each of the applications is treated as the common business object. However, lack of information cannot actually be prevented only by defining the common business object in this way. For example, assuming that there are applications A, B, and C, and the business object is transmitted from A to B and, from B to C. In this case, information is missing in the transfer from A to B, and if the missing information is information required by C, there occurs an apparent problem. Since the transfer of the business object from A to B as well as the transfer of the business object from B to C are performed as different processes in general, a situation must arise where the required information is not set to the business object transmitted from B to C.

In order to prevent this situation from arising, there has been proposed a method of storing data that might miss, as shared data (For example, Japanese Published Patent Application No. 2001-236215 (Pages 12 and 13, and FIGS. 15 and 16).

More specifically, in the method, the data that may be missing in transmitting the business object from a first application to a second application is stored as the shared data, and the stored data is then extracted in transmitting the business object from the second application to a third application.

### SUMMARY OF THE INVENTION

Nevertheless, the above-mentioned lack of information is not necessarily caused by the information missing in the preceding process. Assuming that there are applications A and B, and a business object is transmitted from A to B. In this case, information of the business object that the A outputs might contain only a part of information of the business object that the B requires. This is because each of the applications usually holds only information necessary for being used by the application per se. The method described in the Patent Document 1 may not be able to deal with this case. Namely, according to the method of the Patent Document 1, it is premised that an attribute which is prepared/updated by an application in an upstream process of a business process is referred to by an application in a downstream process thereof. Accordingly, there has been a problem such that an attribute held by an application that has not appeared in the upstream process of the business process has not been able to be referenced.

The present invention was made to solve the technical problem as described above. It is, therefore, an object of the present invention to allow an application in the downstream process to reference attribute even when the attribute is held by an application which does not appear in the upstream process of the business process.

Taking the described object into consideration, in accordance with the present invention, it is configured in such a way that a referenced application of an attribute of a business object is defined in an integrated server for every other attribute of business objects in advance, and when the integrated server transmits any one of the business objects, a value acquired from the referenced application is set to the attribute.

More specifically, an apparatus in accordance with the present invention includes a reception means for receiving a business object from a first application, a transmission means for transmitting the business object received by the reception means to a second application, a means for storing identification information of a referenced application which holds a value of an attribute for every other attribute included in the business object to be transmitted to the second application, and a setting means for setting a value to be set to a specific attribute of a business object by acquiring it from the referenced application corresponding to the specific attribute prior to the transmission of the business object by the transmission means.

Moreover, the present invention, in an apparatus for integrating a plurality of applications, is also comprised of a method of transmitting, to a second application, a second business object acquired by converting a first business object received from a first application.

In that case, the method in accordance with the present invention includes the steps of: reading from a memory unit identification information of a referenced application which holds a value of an attribute required for a conversion from the first business object to the second business object, and converting the first business object into the second business object by referencing the referenced application indicated by the identification information that has been read.

Further, the present invention may also be comprised of a program for making the apparatus for integrating a plurality of applications achieve a predetermined function.

In accordance with the present invention, even if an attribute is held by an application not appearing in the upstream process of a business process, the application in the downstream process is able to reference the attribute.

### BRIEF DESCRIPTION OF THE DRAWINGS

FIG. 1 is a view showing an entire configuration of a system to which an embodiment of the present invention is applied;

FIG. 2 is a block diagram showing a hardware configuration of an integrated server according to the embodiment of the present invention;

FIG. 3 is a block diagram showing a functional configuration of the integrated server according to the embodiment of the present invention;

FIG. 4 is a view showing an example of stored contents of a business process definition storage section according to the embodiment of the present invention;

FIG. 5 is a view showing an example of stored contents of an I/F definition storage section and a reference definition storage section, and a schematic system operation according to the embodiment of the present invention;

FIG. 6 is a flow chart showing an operation of automatically generating a reference definition according to the embodiment of the present invention;

FIG. 7 is a flow chart showing an operation of transferring a business object according to the embodiment of the present invention;

FIG. 8 is a view showing an example of an I/F definition for explaining a specific operation according to the embodiment of the present invention;

FIG. 9 is a view for explaining a production order business process among the specific operations according to the embodiment of the present invention;

FIG. 10 is a view for explaining a delivery order business process among the specific operations according to the embodiment of the present invention; and

FIG. 11 is a view for explaining a delivery completion notice business process among the specific operations according to the embodiment of the present invention.

### DETAILED DESCRIPTION OF THE INVENTION

Hereinafter, a description for explaining a best mode (hereinafter, referred to as “an embodiment”) of carrying out the present invention in detail will be provided, with reference to the accompanying drawings.

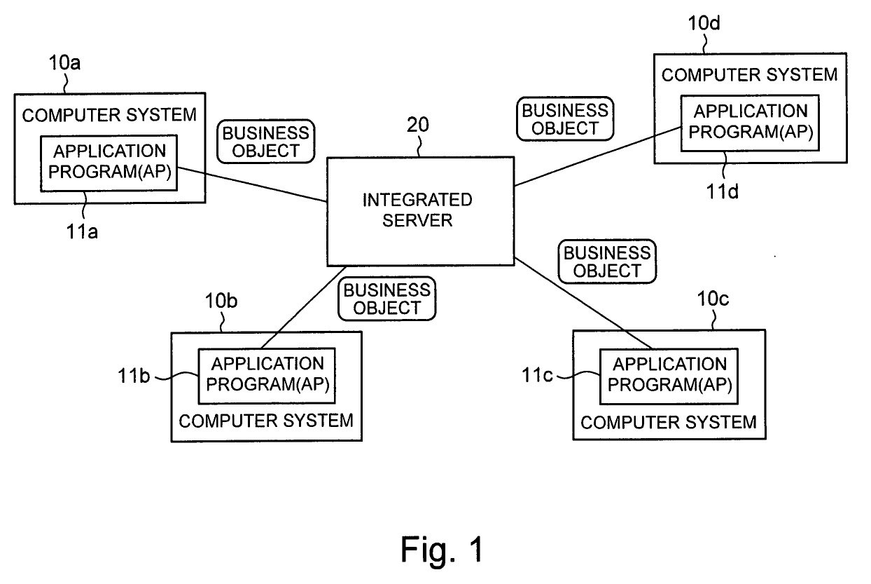

As shown in FIG. 1, the present embodiment includes computer systems 10a through 10d, and an integrated server 20 for serving as a hub that integrates these computer systems. Moreover, application programs (hereinafter, referred to as “AP”) 11a, AP11b, AP11c, and AP11d are run on the associated computer systems 10a, 10b, 10c, and 10d, respectively. These AP11a through AP11d transmit or send a business object (hereinafter, referred to as “BO”) to the integrated server 20, and receive BO from the integrated server 20.

It is considered that the described system could form, for example, a typical system in which the computer system 10a constitutes a CRM (Customer Relationship Management) system, the computer system lob an ERP (Enterprise Resource Planning) system, the computer system 10c an MES (Manufacturing Execution System), and the computer system 10d a delivery management system (Logistics), respectively. In that case, the computer system 10a accepts an order from a customer and sends the ordering information to the computer system 10b as a BO. The computer system lob then creates a production plan of an ordered product and sends out a production order to the computer system 10c as a BO. Subsequently, when the product is produced in practice, the computer system 10c sends a delivery order to the computer system 10d as a BO. It should be understood that four computer systems are shown in FIG. 1, but the number of computer systems may be three or less, and may be five or more.

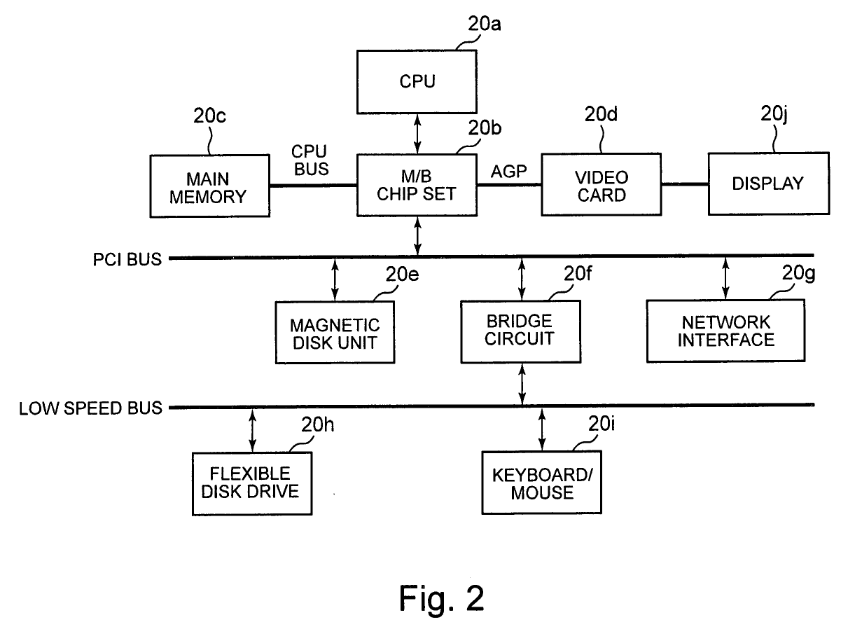

FIG. 2 is a view schematically illustrating an example of a hardware configuration of a computer suitable for being used as the integrated server 20 in this embodiment. The computer illustrated in FIG. 2 includes a CPU (Central Processing Unit) 20a that serves as operation means, a main memory 20c connected to the CPU 20a via a M/B (mother board) chip set 20b and a CPU bus, and a video card 20d and a display 20j, which are similarly connected to the CPU 20a via the M/B chip set 20b and an AGP (Accelerated Graphics Port). Also, the hardware configuration includes a magnetic disk unit (HDD) 20e and a network interface 20g which are connected to the M/B chip set 20b via a PCI (Peripheral Component Interconnect) bus. The configuration further includes a flexible disk drive 20h and a keyboard/mouse 20i, which are connected from the PCI bus to the M/B chip set 20b via a bridge circuit 20f and a low speed bus, such as an ISA (Industry Standard Architecture) bus.

It should be noted that FIG. 2 illustrates only an example of the hardware configuration of the computer for realizing the present embodiment, but as far as this embodiment may be applicable, other various configurations may be employed. For example, a configuration in which only video memory may be mounted instead of provision of the video card 20d to thereby process an image data with the CPU 20a may be employed. Moreover, as an external memory unit, a drive for CD-R (Compact Disc Recordable) or DVD-RAM (Digital Versatile Disc Random Access Memory) may be provided via an interface, such as ATA (AT Attachment), SCSI (Small Computer System Interface), or the like.

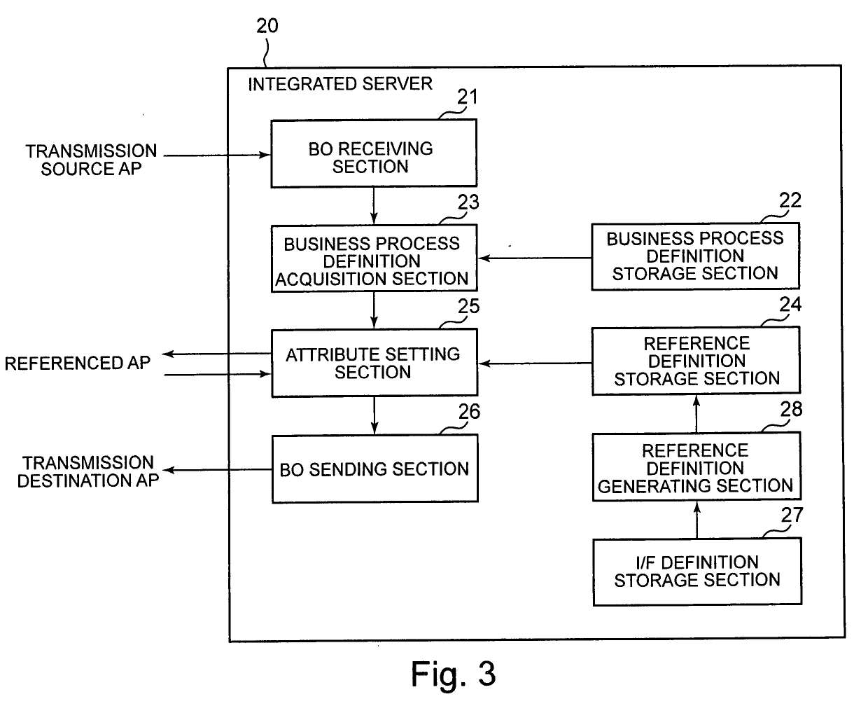

Referring now to FIG. 3, an explanation of a functional configuration of the integrated server 20 according to this embodiment will be provided. The integrated server 20 according to this embodiment includes a BO receiving section 21, a business process definition storage section 22, a business process definition acquisition section 23, a reference definition storage section 24, an attribute setting section 25, a BO sending section 26, an I/F definition storage section 27, and a reference definition generating section 28. The BO receiving section 21 receives BO from a transmission source AP. The business process definition storage section 22 stores a definition on a business process. The business process definition acquisition section 23 acquires a business process definition corresponding to BO that was received (hereinafter, referred to as “received BO”). Incidentally, a specific example of the business process definition will be described later.

Meanwhile, the reference definition storage section 24 stores the reference definition which defines AP to be referenced (hereinafter, referred to as “referenced AP”) in order to acquire a value to be set to an attribute of BO to be transmitted (hereinafter, referred to as “transmission BO”). Incidentally, a specific example of the reference definition will also be described later. The attribute setting section 25 refers to this reference definition and sets a value acquired from the referenced AP if needed to the attribute of the transmission BO. The BO sending section 26 transmits to a transmission destination AP the transmission BO to which the attribute has been set. Meanwhile, the I/F definition storage section 27 stores an interface definition which defines an attribute of each BO in an interaction with the integrated server 20 (hereinafter, referred to as “I/F definition”). Incidentally, a specific example of the I/F definition will also be described later. Meanwhile, the reference definition generating section 28 is a functional section automatically generating the reference definition from the I/F definition, and may also be understood as a determination means for determining the referenced AP.

It should be noted that each of these function sections may be realized by the cooperation of software and hardware resources. Specifically, the CPU of the integrated server 20 reads a program for realizing the BO receiving section 21, the business process definition acquisition section 23, the attribute setting section 25, the BO sending section 26, and the reference definition generating section 28 into the main memory from the external memory unit, and performs processing while referring, as required, to information stored in the business process definition storage section 22, the reference definition storage section 24, and the I/F definition storage section 27, which can be regarded as the external memories.

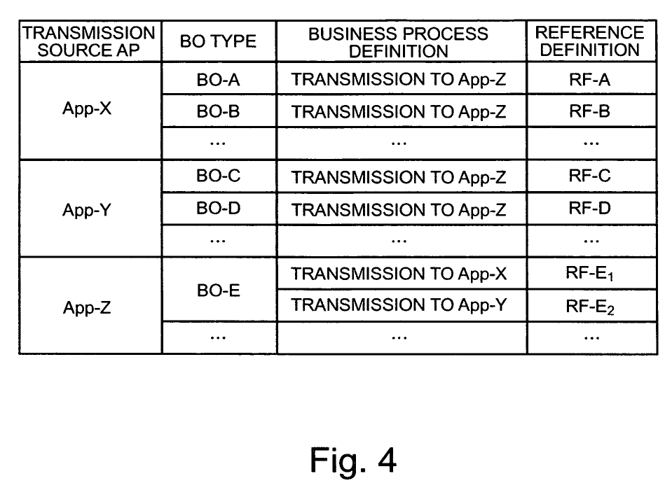

Referring now to FIG. 4, a description to explain specific stored contents of the business process definition storage section 22 will be provided hereinbelow. As best shown in the drawing, the business process definition storage section 22 stores a correspondence among the transmission source AP, the BO type, the business process definition, and the reference definition. More specifically, the business process definition defines, when a certain type of BO is received from a certain transmission source AP, what kind of business process should be executed, and which reference definition should be used at that time. For example, assuming that BO of BO type “BO-A” is received from a transmission source AP “App-X”, a business process of “transmitting BO to “App-Z”” will be executed. In that case, a value acquired from the referenced AP defined in a reference definition “RF-A” will also be set to the attribute of the transmission BO as required.

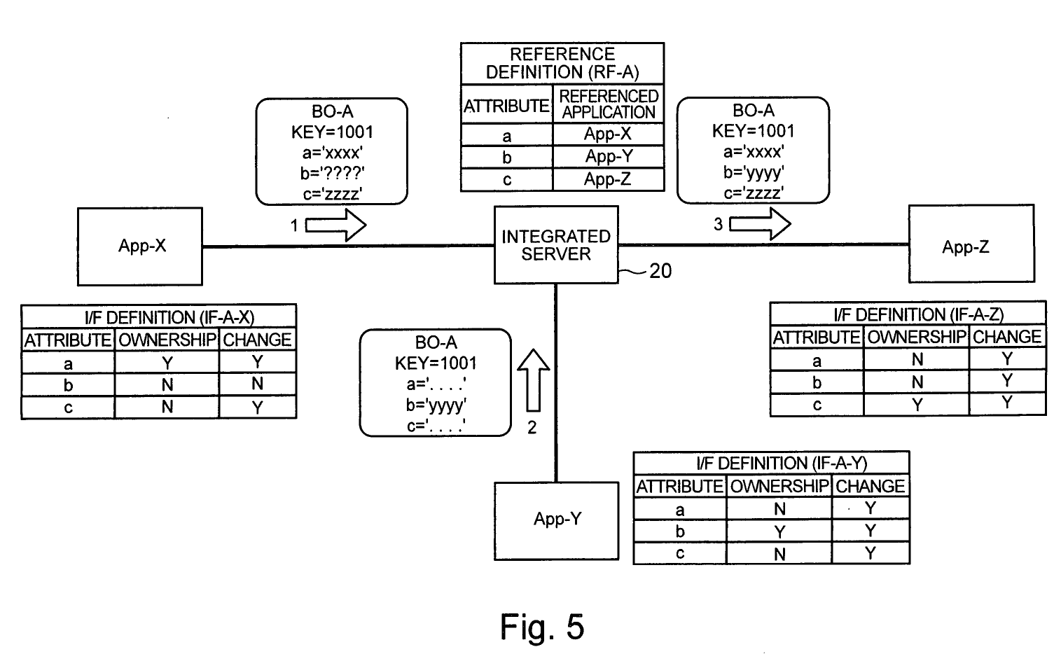

Referring now to FIG. 5, an explanation of the specific memory contents of the reference definition storage section 24 and the I/F definition storage section 27, and an outline of the operation according to this embodiment will be provided. It should be noted that FIG. 5 shows a case where a record corresponding to “KEY=1001” of BO “BO-A” having attributes a, b, and c is sent to “App-Z” from “App-X” by way of the integrated server 20. Accordingly, as a reference definition stored in the reference definition storage section 24, “RF-A” corresponding to the transmission destination “App-X” and the BO type “BO-A” in FIG. 4 is indicated. Specifically, the reference definition “IRF-A” defines the fact that values to be set to the attributes a, b, and c should be acquired from “App-X” “App-Y”, and “App-Z”, respectively. Hence, the present embodiment will operate in the following manner as outlined below.

First, a record corresponding to “KEY=1001” of “BO-A” is transmitted from “App-X” to the integrated server 20, as shown by an arrow 1. In that case, “xxxx”, “????”, and “zzzz” are set to the attributes a, b, and c of “BO-A”. The integrated server 20 now acquires the acquisition destination of a value to be set to each attribute by referring to the reference definition “IRF-A”. Specifically, the integrated server 20 becomes aware of the fact that values to be set to the attributes a, b, and c should be acquired from “App-X”, “App-Y”, and “App-Z”, respectively. As for the attribute a, since the referenced AP is the same as the transmission source AP, the attribute of the received BO may be sent as the attribute of the transmission BO as it is, so that any processing to make query about the referenced AP and to acquire a value to be set to the attribute will not be performed. Also, as for the attribute c, since the referenced AP is the same as the transmission destination AP, setting of a value to the attribute of the transmission BO can also be performed at the transmission destination, and therefore no processing to make query about the referenced AP and to acquire a value to be set to the attribute will be performed.

Meanwhile, as for the attribute b, since the referenced AP is different from not only the transmission source AP but also the transmission destination AP, processing to query about the referenced AP and to acquire a value to be set will be performed. That is to say, as shown by an arrow 2, “yyyy” that is the value to be set to the attribute b is acquired from “App-Y”. Specifically, when the integrated server 20 requests “App-Y” for transmission of a record corresponding to “KEY=1001” of “BO-A”, “App-Y” sends the record including “yyyy” to the integrated server 20 as an acknowledge message. As shown by an arrow 3, “BO-A” in which “yyyy” is set to the attribute b is passed to “App-Z” from the integrated server 20.

Incidentally, taking characteristics of the business process into consideration, the reference definition may be stored by manually defining the referenced AP of the value set to each attribute. Alternatively, the reference definition may be automatically generated based on the I/F definition of the business object in each application. The I/F definition storage section 27 stores the respective I/F definitions of “App-X”, “App-Y”, and “App-Z”. Specifically, “App-X” stores information in an I/F definition “IF-A-X” of “App-X” that the attribute a is owned and can be changed, the attribute b is neither owned nor can be changed, and the attribute c is not owned but can be changed. In addition, “App-Y” stores information in an I/F definition “IF-A-Y” of “App-Y” that the attribute a is not owned but can be changed, the attribute b is owned and can be changed, and the attribute c is not owned but can be changed. Moreover, “App-Z” stores information in an I/F definition “IF-A-Z” of “App-Z” that the attribute a is not owned but can be changed, the attribute b is not owned but can be changed, and the attribute c is owned and can be changed.

According to the example in FIG. 5, it is intended that the value to be set to each attribute of the BOs will be acquired from AP that owns and can change the attribute, namely, AP having original data of the attribute (hereinafter, referred to as “owner AP”). Since it is stored in the I/F definition “IF-A-X”that “App-X” is therefore the owner AP of the attribute a, the referenced AP of the attribute a results in “App-X” in the reference definition. Further, since it is stored in the I/F definition “IF-A-Y” that “App-Y” is the owner AP of the attribute b, the referenced AP of the attribute b results in “App-Y” in the reference definition. Moreover, since it is stored in the I/F definition “IF-A-Z” that “App-Z” is the owner AP of the attribute c, the referenced AP of the attribute c results in “App-Z” in the reference definition.

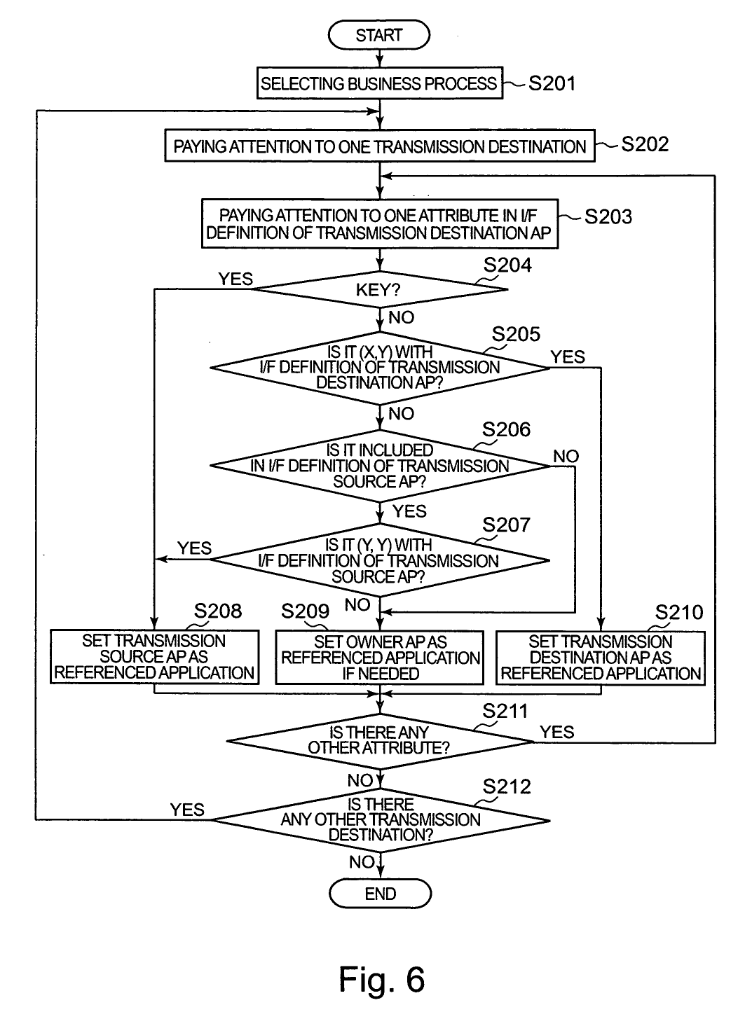

Referring now to FIG. 6, an explanation of an ordinary operation in automatically generating the reference definition from the I/F definition will be provided hereinbelow.

First, the reference definition generating section 28 selects the business process definition of a specific transmission source AP and a specific BO type from the business process definition storage section 22 (Step 201), and directs attention to a given transmission destination AP (Step 202). In the example of FIG. 4, assuming that the business process corresponding to the transmission source “App-X” and the BO type “BO-A” are selected, attention is paid to the transmission destination “App-Z”.

Attention is then directed to a given attribute by the I/F definition of the transmission destination AP (Step 203). In the example of FIG. 5, attention is directed to the attributes a, b, and c in a predetermined sequence.

Next, the reference definition generating section 28 determines whether or not the attribute to which attention is directed is a key item (Step 204), and sets the transmission source AP to the referenced AP of the reference definition when determined as being the key item (Step 208). In the example of FIG. 5, since none of the attributes a, b, and c is the key item, the processing proceeds to step 205.

Additionally, the reference definition generating section 28 determines whether or not the attribute to which attention is paid is (ownership, change) =(Y, Y) in the I/F definition of the transmission destination AP (Step 205), and sets the transmission destination AP to the referenced AP of the reference definition when determined as being (Y, Y) (Step 210). In the example of FIG. 5, since the attribute c satisfies this condition, “App-Z” which is the transmission destination AP is set to the attribute c in the reference definition.

Further, the reference definition generating section 28 determines whether or not the attribute to which attention is directed is included in the I/F definition of the transmission source AP (Step 206), and when it is determined to be not included in the I/F definition, the processing proceeds to Step 209. Meanwhile, when it is determined to be included in the I/F definition, the reference definition generating section 28 determines whether or not (ownership, change) in the I/F definition of the transmission source AP is (Y, Y) (Step 207). As the result of the determination, when it is (Y, Y), the transmission source AP will be set to the referenced AP of the reference definition (Step 208). In the example of FIG. 5, since the attribute a satisfies this condition, “App-X” which is the transmission source AP is set to the attribute a in the reference definition.

Meanwhile, either if it is determined to be not included in the I/F definition at step 206, or if it is determined that (ownership, change) in the I/F definition of the transmission source AP is not (Y, Y) at step 207, the owner AP is set to the referenced AP as required (Step 209). In the example of FIG. 5, since the attribute b satisfies the latter condition, “App-Y” which is the owner AP is set to the attribute b in the reference definition.

Then, the reference definition generating section 28 determines whether or not there is any other attribute (Step 211), and when there is still an attribute, processing of the Steps 203 through 210 will be repeated. On the contrary, when there is no other attribute, it will be determined whether or not there is any other transmission destination AP (Step 212). As a result, when it is determined that there is a transmission destination AP, processing of the Steps 202 through 211 will be repeated, and on the contrary, if there is no transmission destination AP, processing will be completed.

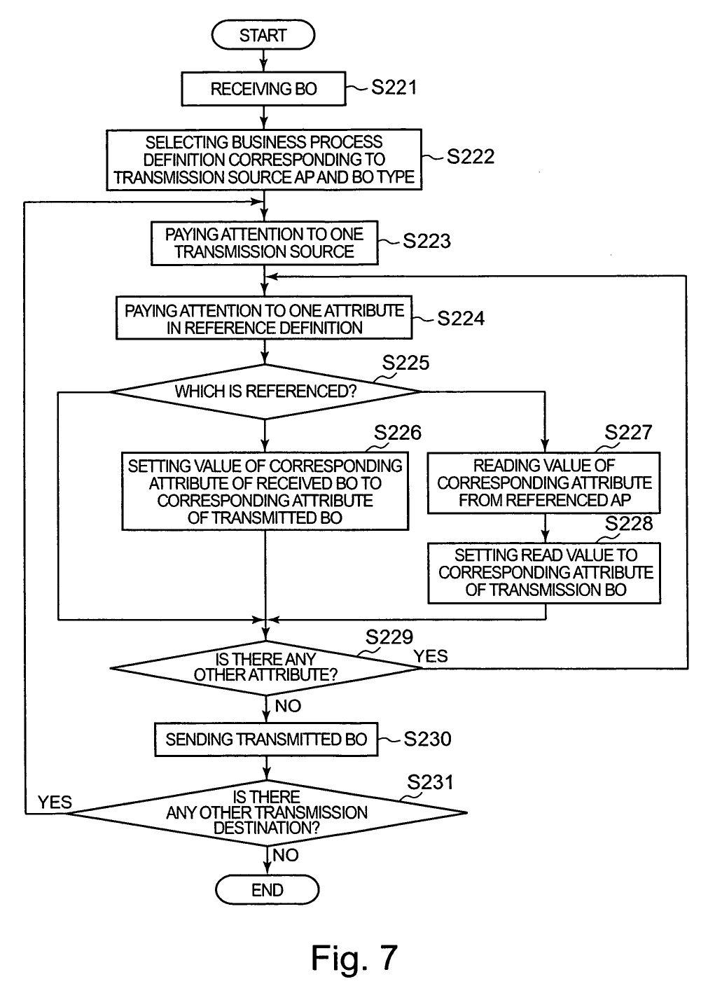

Referring now to FIG. 7, an explanation of an ordinary operation conducted when the integrated server 20 transmits BO will be provided hereinbelow. First, the BO receiving section 21 receives BO from the transmission source AP (Step 221). The business process definition acquisition section 23 then refers to the business process definition storage section 22, and selects a definition of the business process corresponding to the transmission source AP and BO type of the received BO (Step 222). In the example of FIG. 4, “transmission to App-Z” which is the business process defined to the transmission source AP “App-X” and BO type “BO-A” is acquired. Subsequently, the attribute setting section 25 directs attention to a given transmission destination AP (Step 223), and directs attention a given attribute in the reference definition defined to a combination of this transmission source AP and transmission destination AP (Step 224). In the examples of FIGS. 4 and 5, the attribute setting section 25 acquires the reference definition “RF-A” defined to the combination of the transmission source AP “App-X” and the transmission destination AP “App-Z”, and attention is directed to the attributes a, b, and c in a predetermined sequence.

Next, the attribute setting section 25 refers to a column of the referenced AP of the reference definition, and determines whether the referenced AP is the transmission destination AP, the transmission source AP, or any other AP (Step 225). As the result of this determination, if the referenced AP is the transmission destination AP, processing proceeds to step 229, without doing anything. Additionally, if the referenced AP is the transmission source AP, the value set to the attribute of the received BO is set to the same attribute of the transmission BO as it is (Step 226), and the processing proceeds to step 229. Moreover, if the referenced AP is another AP, the value of the attribute is read from the referenced AP (Step 227), and is set to the same attribute of the transmission BO (Step 228). In the example of FIG. 5, when attention is directed to the attribute a, since the referenced AP is the same as the transmission source AP, the value of the attribute of the received BO is set to the value of the attribute of the transmission BO, and the processing proceeds to step 229. When attention is directed to the attribute b, since the referenced AP is different from not only the transmission source AP but also the transmission destination AP, the value is acquired from the referenced AP so as to be set to the attribute b, and the processing proceeds to step 229. Additionally, when attention is directed to the attribute c, since the referenced AP is the same as the transmission destination AP, the processing proceeds to step 229, without doing anything.

Thereafter, it is determined whether or not there is any other attribute (Step 229), and when it is determined that there is another attribute, the processing of steps 224 through 228 will be repeated. When there is no other attribute, the BO transmitting section 26 transmits the transmission BO to the transmission destination AP (Step 230). Finally, it is determined whether or not there is any other transmission destination (Step 231), and when determined that there is another transmission destination, the processing of steps 223 through 230 will be repeated, and processing will be completed when there is no other transmission destination. In the example of FIG. 5, however, since only “App-Z” has been assumed as the transmission destination, processing of steps 223 through 230 has been performed only once. However, as shown in FIG. 4, when a plurality of transmission destination APs exist in such a case that BO of a BO type “BO-E” is received from the transmission source AP “App-Z”, the processing of steps 223 through 230 will be repeated as many time as the number of the transmission destination APs.

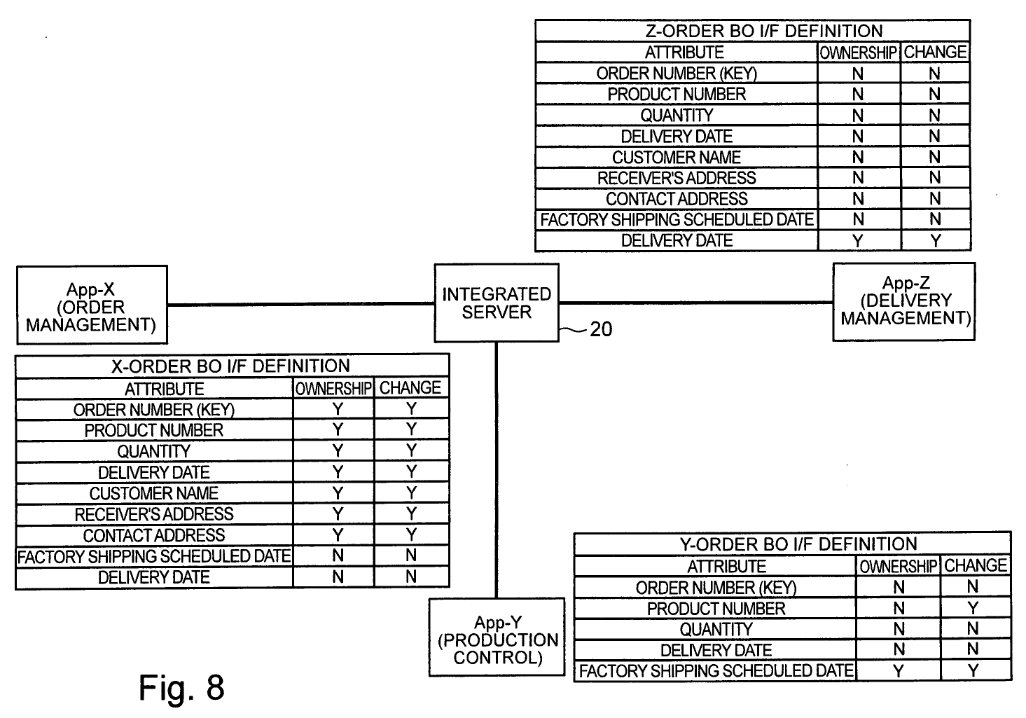

Next, a description to explain this embodiment will be provided by using a specific example. As shown in FIG. 8, this specific example represents an exemplary system in which “App-X” for performing an order management, “App-Y” for performing a production control, and “App-Z” for performing a delivery management are integrated by the integrated server 20. In addition, it is assumed that the I/F definition in each of “App-X”, “App-Y”, and “App-Z” will be given as shown in FIG. 8. In this system, first, “App-X” instructs a production of an ordered product by sending an order BO to “App-Y” (production order business process). Next, “App-Y” instructs a delivery of a produced product by sending the order BO to “App-Z” (delivery order business process). Finally, “App-Z” notifies a completion of the delivery of the product by sending the order BO to “App-X” (delivery completion notice business process). Hereinafter, detailed operation in these business processes will be explained step by step.

(Production Order Business Process)

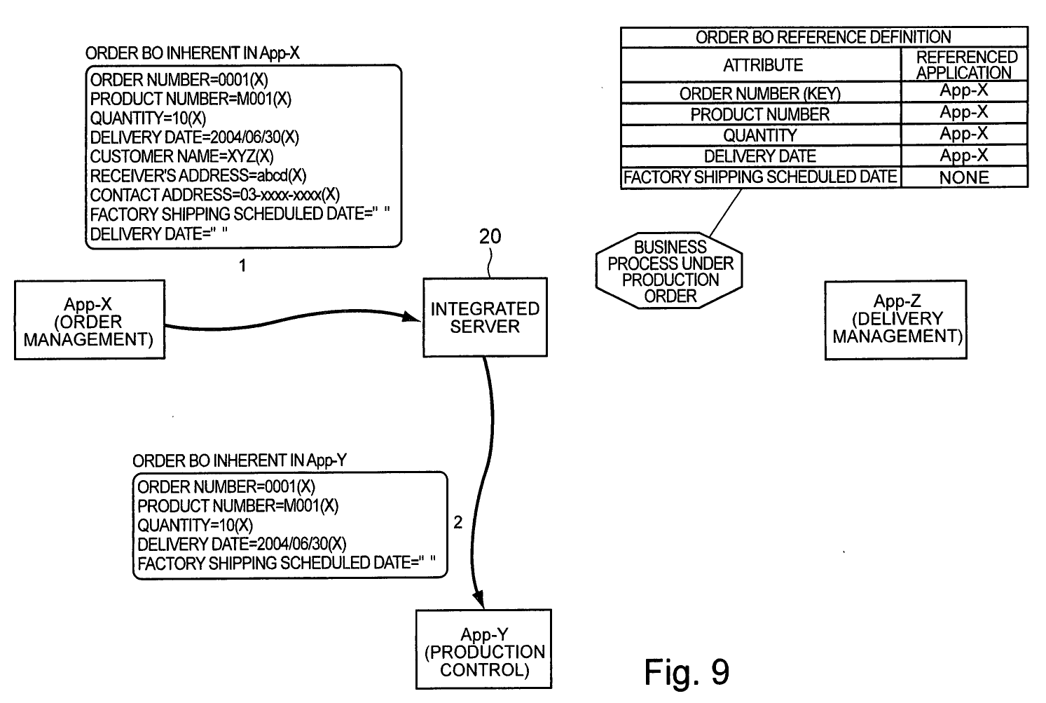

Referring to FIG. 9, a production order business process will be explained. It should be noted that “( )” behind a value set to the attribute of each order BO represents from which application the value is acquired. Prior to execution of the production order business process, the reference definition (order BO reference definition) as shown in FIG. 9 has been generated. Operation of generating this reference definition will be explained in accordance with the flow as shown in the flowchart of FIG. 6. First, at step 201, a production order business process definition is selected, and “App-Y” is then selected as the transmission destination AP at step 202. At step 203 , attention is directed to an attribute “order number (KEY)” defined in “Y-order BO I/F definition” which is the I/F definition of the transmission destination AP “App-Y”. At step 204, since it is determined that the order number (KEY)” is the key item, processing proceeds to step 208, and “App-X” which is the transmission source AP is set to the “order BO reference definition” in FIG. 9 as the referenced AP. Since it is then determined that there is another attribute at step 211, the processing returns to step 203.

Next, at step 203, attention is directed to the next attribute “product number” defined in “Y-order BO I/F definition” which is the I/F definition of the transmission destination AP “App-Y”. Since it is determined that the “product number” is not the key item at step 204, the processing proceeds to step 205. In addition, since (ownership, change) is not (Y, Y) in the I/F definition of the transmission destination AP “App-Y”, the processing proceeds to step 206. Further, since the attribute “product number” exists in the I/F definition of the transmission source AP “App-X”, the processing proceeds to Step 207. Still further, since (own, change) is (Y, Y) in the I/F definition of the transmission source AP “App-X”, processing proceeds to Step 208, and “App-X” which is the transmission source AP is set to the “order BO reference definition” in FIG. 9 as the referenced AP. Since it is then determined that there is another attribute at Step 211, step returns to Step 203.

Subsequently, attention is directed to the next attribute “quantity” defined in “Y-order BO I/F definition” which is the I/F definition of the transmission destination AP “App-Y”, and similar processing is performed, so that “App-X” which is the transmission source AP is set to the “order BO reference definition” in FIG. 9 as the referenced AP. “App-X” which is the transmission source AP is set also to an attribute “delivery date” in a similar manner. Then, since it is determined that there is another attribute at Step 211, processing returns to Step 203.

Subsequently, at Step 203, attention is directed to the next attribute “factory shipping scheduled date” defined in “Y-order BO I/F definition” which is the I/F definition of the transmission destination AP “App-Y”. Since a determination is made that “factory shipping scheduled date” is not the key item at Step 204, processing proceeds to Step 205. Since (ownership, change) is (Y, Y) in the I/F definition of the transmission destination AP “App-Y”, processing then proceeds to Step 210, and “None” is set to “order BO reference definition” in FIG. 9 as the referenced AP. At this stage, it should be noted that since “None” sets a value in the transmission destination AP as the value of the attribute, it represents that any value is not set during transmission.

Further, the operation of the integrated server 20 upon receipt of the order BO from “App-X” after the order BO reference definition as shown in FIG. 9 is generated, will be described in detail with reference to the flowchart of FIG. 7. First, at Step 221, the order BO is received from “App-X”, and “transmit to “App-Y”” is acquired as the business process definition at Step 222. Next, at Step 223, attention is directed to the transmission destination AP “App-Y”, and attention is then directed, at Step 224, to the attribute “order number (KEY)” defined in “order BO reference definition” in FIG. 9. Since the referenced AP is determined to be the transmission source AP “App-X” at Step 225, the value set to the attribute “order number (KEY)” of the received BO is set to the attribute “order number (KEY)” of the transmission BO. Since it is then determined at Step 229 that there is another attribute, processing returns to Step 224.

Subsequently, at Step 224, attention is paid to the next attribute “product number” defined in “order BO reference definition” in FIG. 9, and similar processing is performed, so that the value set to the attribute “product number” of the received BO is set to the attribute “product number” of the transmission BO. Moreover, as for the attributes “quantity” and “delivery date” the values set to the corresponding attributes of the received BO are set to the same attributes of the transmission BO, respectively, in a manner similar to that. Since it is then determined that there is another attribute at Step 229, step returns to Step 224.

Next, at Step 224, attention is directed to the next attribute “factory shipping scheduled date” defined to “order BO reference definition” in FIG. 9. Since it turns out at Step 225 that “None” has been set to the referenced AP, nothing is set to the attribute “factory shipping scheduled date” of the transmission BO. Since it is then determined at Step 229 that there is no other attribute, processing proceeds to Step 230, and the transmission BO to which the value is set will be transmitted. Thereafter, as it is determined at Step 231 that there is no transmission destination except “App-Y”, processing is completed.

(Delivery Order Business Process)

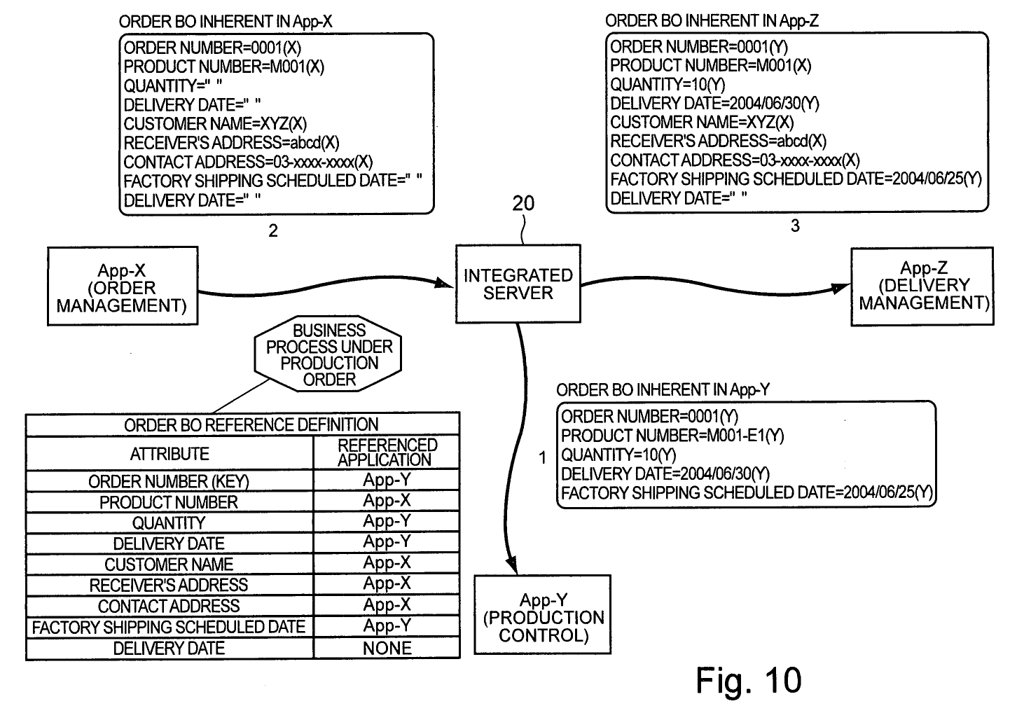

Referring to FIG. 10, an explanation of a delivery order business process will be provided herein below. It should be noted that “( )” behind values set to the respective attributes of order BO represents from which application the value is acquired. Prior to execution of the delivery order business process, the reference definition (order BO reference definition) as shown in FIG. 10 is generated. Operation of generating this reference definition will be explained with reference to the flowchart of FIG. 6. First, at Step 201, a delivery order business process definition is selected , and “App-Z” is selected as the transmission destination AP at Step 202. At Step 203, attention is paid to the attribute “order number (KEY)” defined in “Z-order BO I/F definition” which is the I/F definition of the transmission destination AP “App-Z”. Since it is determined that “order number (KEY)” is the key item at Step 204, processing proceeds to Step 208, so that “App-Y” which is the transmission source AP is set to “order BO reference definition” in FIG. 10 as the referenced AP. Since it is then determined that there is another attribute at Step 211, processing returns to Step 203.

Next, at Step 203, attention is directed to the next attribute “product number” defined in “Z-order BO I/F definition” which is the I/F definition of the transmission destination AP “App-Z”. Since it is determined that the “product number” is not the key item at Step 204, processing proceeds to Step 205. In addition, since (ownership, change) is not (Y, Y) in the I/F definition of the transmission destination AP “App-Z”, processing proceeds to Step 206. Further, since the attribute “product number” exists in the I/F definition of the transmission source AP “App-Y”, processing proceeds to Step 207. Still further, since (ownership, change) is not (Y, Y) in the I/F definition of the transmission source AP “App-Y”, processing proceeds to Step 209.

Incidentally, in the case of the attribute “product number”, a value received from “App-X” might have been changed in “App-Y”. For example, as shown in FIG. 10, it is a case such that although “M001” has been received as the “product number” from “App-X”, “Product number” in “App-Y” has been changed into “M001-E1” to which specification change information applied to the product manufactured in practice has added. According to this specific example, it is configured in such a way that this change is assumed to be an irreversible change, so that the value to be set to the attribute of BO which is transmitted to “App-Z” is newly acquired from “App-X”. That is to say, “App-X” which is the owner AP is set to “order BO reference definition” in FIG. 10 as the referenced AP. Since it is then determined at Step 211 that there is another attribute, processing returns to Step 203.

Incidentally, as an example of the irreversible change mentioned above, following cases will also be considered in addition to the example as shown in FIG. 10. (1) Case 1: Data formats are different

It is a case such that since a data format of the attribute defined in the I/F definition of “App-X” is different from a data format of the attribute defined in the I/F definition of “App-Y”, information will be missing when the business object is transmitted to “App-Y” from “App-X”. Assuming that a postcode is defined by seven-digit in “App-X”, and by five-digit in “App-Y”, for example. In this case, “App-Y” can not receive sixth and seventh digits of the zip code, thereby leading to newly acquire a value of the zip code from “App-X”. In addition, it may also be considered a case such that an address is separately defined as all prefectures, cities, towns and villages, or the like by “App-X”, but it is collectively defined as one attribute by “App-Y”. In this case, if the integrated server 20 is provided with a function of dividing the address collectively defined as one attribute into all prefectures, cities, towns and villages, or the like, any problem will not be caused. If the integrated server 20 is provided with no such function, however, the value of the address must be newly acquired from “App-X”.

(2) Case 2: Character Encoding Schemes are Different

It is a case such that since a character encoding scheme used in “App-X” is different from a character encoding scheme used in “App-Y”, information will be missing when the business object is transmitted from “App-X” to “App-Y”. Assuming that a character code corresponding to a character “A” is “1111” in “App-X”, and a character code corresponding to a character “A′” is “1112”, for example. In addition, assuming that the character code corresponding to the character “A” is “1111” in “App-Y”, but the character code corresponding to the character “A′” does not exist therein. In this case, even when the character “A′”(character code “1112”) is transmitted from “App-X”, it can be recognized only as the character code “1111” in “App-Y” and therefore, leading to not making a distinction whether the original character is either “A” or “A”′. Therefore, it will lead to newly acquiring a character from “App-X”.

Now, a description of operation in FIG. 10 will be continued again. At Step 203, attention is directed to the next attribute “quantity” defined in “Z-order BO I/F definition” which is the I/F definition of the transmission destination AP “App-Z”. Since it is determined that “quantity” is not the key item at Step 204, step proceeds to Step 205. In addition, since (own, change) is not (Y, Y) in the I/F definition of the transmission destination AP “App-Z”, processing proceeds to Step 206. Further, since the attribute “quantity” exists in the I/F definition of the transmission source AP “App-Y”, processing proceeds to Step 207. Still further, since (ownership, change) is not (Y, Y) in the I/F definition of the transmission source AP “App-Y”, processing proceeds to Step 209. According to this specific example, the transmission source AP is considered as being the referenced AP in this case, and “App-Y” which is the transmission source AP is set to “order BO reference definition” in FIG. 10 as the referenced AP. Then, since it is determined at step 211 that there is another attribute, processing returns to Step 203.

Thereafter, attention is directed to the next attribute “delivery date” defined in “Z-order BO I/F definition” which is the I/F definition of the transmission destination AP “App-Z”, and similar processing is performed, so that “App-Y” which is the transmission source AP is set to “order BO reference definition” in FIG. 10 as the referenced AP. Since it is then determined that there is another attribute at Step 211, processing returns to Step 203.

Next, at Step 203, attention is directed to the next attribute “customer name” defined in “Z-order BO I/F definition”, which is the I/F definition of the transmission destination AP “App-Z”. Since it is determined at Step 204 that “customer name” is not the key item, processing proceeds to Step 205. In addition, since (ownership, change) is not (Y, Y) in the I/F definition of the transmission destination AP “App-Z”, processing proceeds to Step 206. Further, since the attribute “customer name” does not exist in the I/F definition of the transmission source AP “App-Y”, processing proceeds to Step 209. According to this specific example, the owner AP is considered as being the referenced AP in this case, and “App-X”, which is the owner AP is set to “order BO reference definition” in FIG. 10 as the referenced AP. Then, since it is determined at Step 211 that there is another attribute, processing returns to Step 203.

Thereafter, attention is directed to the next attribute “receiver's address” defined in “Z-order BO I/F definition” which is the I/F definition of the transmission destination AP “App-Z”, similar processing is performed, so that “App-X”, which is the owner AP is set to “order BO reference definition” in FIG. 10 as the referenced AP. In addition, “App-X” which is the owner AP is set also to an attribute “contact” in a manner similar to that. Since it is then determined at Step 211 that there is another attribute, processing returns to Step 203.

Next, at Step 203, attention is directed to the next attribute “factory shipping scheduled date” defined in “Z-order BO I/F definition”, which is the I/F definition of the transmission destination AP “App-Z”. Since it is determined at Step 204 that “factory shipping scheduled date” is not the key item, processing proceeds to Step 205. In addition, since (ownership, change) is not (Y, Y) in the I/F definition of the transmission destination AP “App-Z”, processing proceeds to Step 206. Further, since the attribute “factory shipping scheduled date” exists in the I/F definition of the transmission source AP “App-Y”, processing proceeds to Step 207. Still further, since (ownership, change) is (Y, Y) in the I/F definition of the transmission source AP “App-Y”, processing proceeds to Step 208, and “App-Y”, which is the transmission source AP is set to “order BO reference definition” in FIG. 10 as the referenced AP. Since it is then determined at Step 211 that there is another attribute, processing returns to Step 203.

Next, attention is directed to the next attribute “delivery date” defined in “Z-order BO I/F definition”, which is the I/F definition of the transmission destination AP “App-z”. Since it is determined at Step 204 that “delivery date” is not the key item, processing proceeds to Step 205. Since (ownership, change) is (Y, Y) in the I/F definition of the transmission destination AP “App-Z”, processing then proceeds to Step 210, and “None” is set to “order BO reference definition” in FIG. 10 as the referenced AP. It should be noted that since “None” sets a value in the transmission destination AP as a value of the attribute, it represents that the value is not set in transmission.

Moreover, a description of an operation of the integrated server 20 upon receipt of the order BO from “App-Y” after the order BO reference definition shown in FIG. 10 is generated will be provided with reference to the flowchart of FIG. 7. First, at Step 221, the order BO is received from “App-Y”, and ““transmit to “App-Z”” is acquired as the business process definition. Next, at Step 223, attention is directed to the transmission destination AP “App-Z”, and attention is directed, at Step 224, to the attribute “order number (KEY)” defined in “order BO reference definition” in FIG. 10. Since at Step 225, the referenced AP is determined to be the transmission source AP “App-Y”, the value set to the attribute “order number (KEY)” of the received BO is set to the attribute “order number (KEY)” of the transmission BO. Then, since it is determined at Step 229 that there is another attribute, processing returns to Step 224.

Next, at Step 224, attention is directed to the attribute “product number” defined in “order BO reference definition” in FIG. 10. Since the referenced AP is determined, at Step 225, to be “App-X”, which is neither the transmission source AP nor the transmission destination AP, a value to be set to the attribute “product number” is acquired from “App-x” at Step 227, and the value is set at Step 228 to the attribute “product number” of the transmission BO. Then, since it is determined at Step 229 that there is another attribute, processing returns to Step 224.

Next, at Step 224, attention is directed to the attribute “quantity” defined in “order BO reference definition” in FIG. 10. Since the referenced AP is determined, at Step 225, to be the transmission source AP “App-Y”, the value set to the attribute “quantity” of the received BO is set to the attribute “quantity” of the transmission BO. Similar operation will also be performed to the attribute “delivery date”. Since it is then determined at Step 229 that there is another attribute, processing returns to Step 224.

Next, at Step 224, attention is directed to the attribute “customer name” defined in “order BO reference definition” in FIG. 10. Since the referenced AP is determined, at Step 225, to be “App-X”, which is neither the transmission source AP nor the transmission destination AP, a value to be set to the attribute “customer name” is acquired from “App-X” at Step 227, and the value is set at Step 228 to the attribute “customer name” of the transmission BO. Similar operation will also be performed to the attributes “receiver's address” and “contact”. Since it is then determined at Step 229 that there is another attribute, processing returns to Step 224.

Next, at Step 224, attention is directed to the next attribute “factory shipping scheduled date” defined in “order BO reference definition” in FIG. 10. Since the referenced AP is determined, at Step 225, to be the transmission source AP “App-Y”, the value set to the attribute “factory shipping scheduled date” of the received BO is set to the attribute “factory shipping scheduled date” of the transmission BO. Since it is then determined at Step 229 that there is another attribute, processing returns to Step 224.

Next, at Step 224, attention is directed to the attribute “delivery date” defined in “order BO reference definition” in FIG. 10. Since it turns out at Step 225 that “None” is set to the referenced AP, nothing is set to the attribute “delivery date” of the transmission BO. Since it is then determined at Step 229 that there is no other attribute, processing proceeds to Step 230, and the transmission BO to which the value is set will be transmitted. Subsequently, since it is determined at Step 231 that there is no transmission destination except “App-Z”, processing is completed.

(Delivery Completion Notice Business Process)

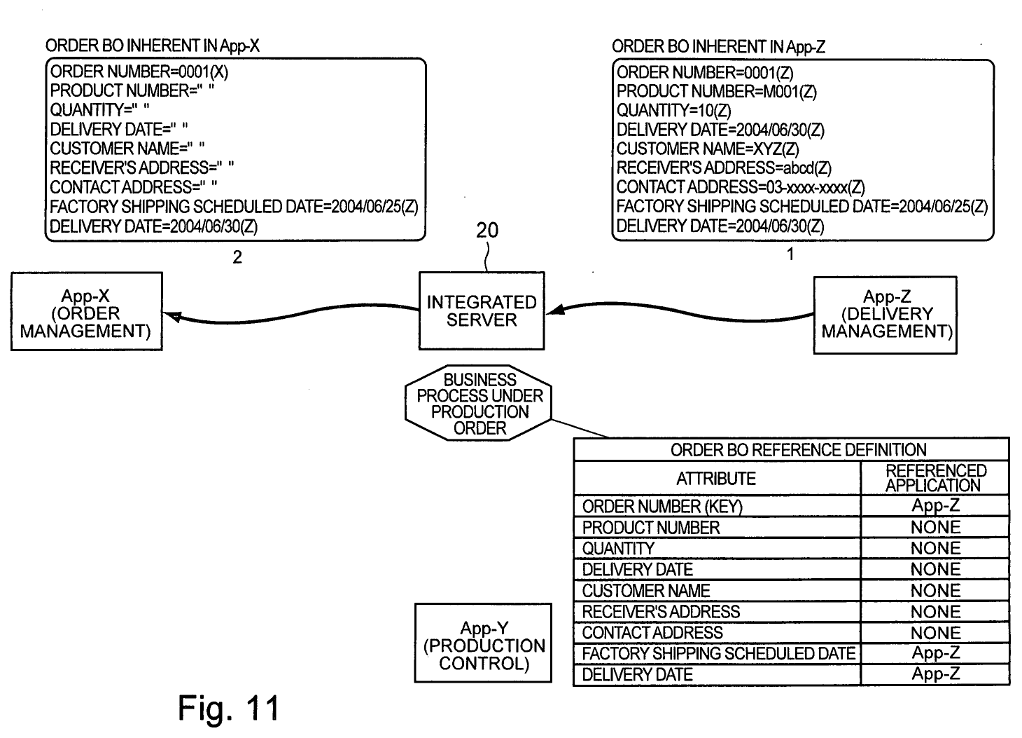

Referring to FIG. 11, an explanation of a delivery completion notice business process will be provided hereinbelow. It should be noted that “( )” behind a value set to the attribute of each order BO represents from which application the value is acquired. Prior to execution of the delivery completion notice business process, the reference definition (order BO reference definition) as shown in FIG. 11 is generated. Operation of generating this reference definition will be explained with reference to the flowchart of FIG. 6. First, at Step 201, a delivery completion notice business process definition is selected , and “App-X” is selected as the transmission destination AP at Step 202. At Step 203, attention is directed to the attribute “order number (KEY)” defined in “X-order BO I/F definition”, which is the I/F definition of the transmission destination AP “App-X”. Since it is determined at Step 204 that the order number (KEY)” is the key item, processing proceeds to Step 208, and “App-Z” which is the transmission source AP is set to “order BO reference definition” in FIG. 11 as the referenced AP. Since it is then determined at Step 211 that there is another attribute, processing returns to Step 203.

Next, at Step 203, attention is directed to the next attribute “product number” defined in “X-order BO I/F definition”, which is the I/F definition of the transmission destination AP “App-X”. Since it is determined at Step 204 that the “product number” is not the key item, processing proceeds to Step 205. Further, since (ownership, change) is (Y, Y) in the I/F definition of the transmission destination AP “App-X”, processing proceeds to Step 210, and “None” is set to “order BO reference definition” in FIG. 11 as the referenced AP. It should be noted that since “None” sets a value in the transmission destination AP as a value of the attribute, it represents that the value is not set during transmission. Since it is then determined at Step 211 that there is another attribute, processing returns to Step 203.

Thereafter, attention is directed to the next attribute “quantity” defined in “X-order BO I/F definition”, which is the I/F definition of the transmission destination AP “App-X”, and similar processing is performed, to set “None” to “order BO reference definition” in FIG. 11 as the referenced AP. “None” is set also to the attributes “delivery date”, “customer name”, “receiver's address”, and “contact” in a similar manner. Since it is then determined at Step 211 that there is another attribute, processing returns to Step 203.

Next, at Step 203, attention is directed to the next attribute “factory shipping scheduled date” defined in “X-order BO I/F definition”, which is the I/F definition of the transmission destination AP “App-X”. Since it is determined at Step 204 that “factory shipping scheduled date” is not the key item, processing proceeds to Step 205. In addition, since (ownership, change) is not (Y, Y) in the I/F definition of the transmission destination AP “App-X”, processing proceeds to Step 206. Further, since the attribute “factory shipping scheduled date” exists in the I/F definition of the transmission source AP “App-Z”, processing proceeds to Step 207. Still further, since (ownership, change) is not (Y, Y) in the I/F definition of the transmission source AP “App-Z”, processing proceeds to Step 209. According to this specific example, the transmission source AP is considered as being the referenced AP in this case, so that “App-Z”, which is the transmission source AP is set to “order BO reference definition” in FIG. 11 as the referenced AP. Since it is then determined at Step 211 that there is another attribute, processing returns to Step 203.

Next, at Step 203, attention is directed to the next attribute “delivery date” defined in “X-order BO I/F definition” which is the I/F definition of the transmission destination AP “App-X”. Since it is determined at Step 204 that “delivery date” is not the key item, processing proceeds to Step 205. In addition, since (ownership, change) is not (Y, Y) in the I/F definition of the transmission destination AP “App-X”, processing proceeds to Step 206. Further, since the attribute “delivery date” exists in the I/F definition of the transmission source AP “App-Z”, processing proceeds to Step 207. Still further, since (own, change) is (Y, Y) in the I/F definition of the transmission source AP “App-Z”, step proceeds to Step 208, and “App-Z”, which is the transmission source AP is set to “order BO reference definition” in FIG. 11 as the referenced AP.

Moreover, operation of the integrated server 20 upon receipt of the order BO from “App-Z” after the order BO reference definition shown in FIG. 11 is generated will be described and explained with reference to the flowchart of FIG. 7. First, Step 221, the order BO is received from “App-Z”, and ““transmit to “App-X”” is acquired as the business process definition at Step 222. Next, at Step 223, attention is directed to the transmission destination AP “App-X”, and attention is directed, at Step 224, to the attribute “order number (KEY)” defined in “order BO reference definition” in FIG. 11. Since the referenced AP is determined at Step 225 to be the transmission source AP “App-Z”, the value set to the attribute “order number (KEY)” of the received BO is set to the attribute “order number (KEY)” of the transmission BO. Then, since it is determined at Step 229 that there is another attribute, processing returns to Step 224.

Next, at Step 224, attention is directed to the attribute “product number” defined in “order BO reference definition” in FIG. 11. Since it turns out at Step 225 that “None” is set to the referenced AP, nothing is set to the attribute “product number” of the transmission BO. “None” is similarly set to the attributes “quantity”, “delivery date”, “customer name”, “receiver's address”, and “contact”, respectively. Then, since it is determined at Step 229 that there is another attribute, processing returns to Step 224.

Next, at Step 224, attention is directed to the next attribute “factory shipping scheduled date” defined in “order BO reference definition” in FIG. 11. Since the referenced AP is determined, at Step 225, to be the transmission source AP “App-Z”, the value set to the attribute “factory shipping scheduled date” of the received BO is set to the attribute “factory shipping scheduled date” of the transmission BO. In addition, as for the attribute “delivery date”, the value set to the attribute “delivery date” of the received BO is set to the same attribute of transmission BO in a similar manner. Since it is then determined at Step 229 that there is no other attribute, processing proceeds to Step 230, SO that the transmission BO to which the value is set will be transmitted. Subsequently, since it is determined at Step 231 that there is no transmission destination except “App-X”, processing is completed.

As described above, according to the present embodiment, a configuration is taken in a manner such that the referenced AP of the attribute is defined in the integrated server for every attribute of the business object, and when the integrated server transmits the business object, the value acquired from the referenced AP is set to the attribute. As a result of the described configure, it is possible for the application in the downstream process to make reference to the attribute even when the attribute is held by the application, which does not appear in the upstream process of the business process.

It should be appreciated that, in the present embodiment, the description has been provided by directing attention to the transmission of the business object, but according to a different aspect, the present invention can be taken as a concept of more general data transmission technique. In that case, the attribute of the business object can be comprehended as a data item in a data record. Moreover, according to this embodiment of the present invention, such an embodiment that no common business object is provided on the integrated server 20 has been described, but it is to be understood that a configuration might be adopted in which some common business object is provided on the integrated server 20.

1. An apparatus for integrating a plurality of applications, comprising:
means for receiving a business object from a first application;
means for transmitting the business object received by the receiving means to a second application;
means for storing identification information of a referenced application that holds a value of an attribute for every other attribute included in said business object transmitted to the second application; and
means for setting, prior to the transmission of the business object by the transmitting means, a value to be set to a specific attribute of said business object by acquiring the value from the referenced application, which corresponds to said specific attribute.

2. The apparatus according to claim 1, wherein said specific attribute to which the acquired value is set by the setting means is an attribute to be not held by the business object received from the first application.

3. The apparatus according to claim 1, wherein said specific attribute to which the acquired value is set by the setting means is an attribute that said business object received from the first application holds in a form to be not required by said second application.

4. The apparatus according to claim 1, further comprising:
means for determining the referenced application based on information of the attribute of the business object that each of a plurality of predetermined applications controls.

5. The apparatus according to claim 1, further comprising:
means for determining the referenced application based on information of the attribute of the business object that each of a plurality of predetermined applications controls, and information indicating whether or not original data is set to each said attribute.

6. The apparatus according to claim 5, wherein said determining means determines, when the original data is set to a specific attribute of the business object that a specific application controls, the specific application as the referenced application that corresponds to said specific attribute.

7. A method of transmitting, in an apparatus for integrating a plurality of applications, a second business object, which is acquired by converting a first business object received from a first application, to a second application, comprising the steps of:
reading identification information of a referenced application that holds a value of attribute required for a conversion of said first business object to said second business object, from a storage unit; and
converting said first business object to said second business object by referring to said referenced application indicated by the read identification information.

8. The method according to claim 7, wherein the conversion from the first business object to the second business object comprises a conversion to compensate for data that said first business object is short of but that said second application needs.

9. The method according to claim 7, wherein the conversion from the first business object to the second business object comprises a conversion to return a portion of the first business object that has irreversibly changed to an original state.

10. The method according to claim 7, further comprising the step of:
determining said referenced application based on information of interfaces between respective of said plurality of applications and external sources.

11. The method according to claim 7, wherein when a specific application in said plurality of applications holds data to be transmitted as said second business object, said method further comprising the step of:
determining the specific application as said reference application.

12. A program product for allowing the apparatus for integrating the plurality of applications to execute the method according to claim 7.
